(19) United States
(12) Patent Application Publication
(10) Pub. No.: US 2013/0107442 A1
(43) Pub. Date: May 2, 2013

(54) FLASH DRIVE WITH PROTECTING CASINGS

(71) Applicant: HAI-QING ZHOU, Shenzhen City (CN)

(72) Inventor: HAI-QING ZHOU, Shenzhen City (CN)

(21) Appl. No.: 13/655,491

(22) Filed: Oct. 19, 2012

(30) Foreign Application Priority Data
Oct. 28, 2011 (CN) 201110333536.1

(51) Int. Cl. G06F 1/16

(52) U.S. Cl. 361/679.32

(57) ABSTRACT

A flash drive includes a main body and two casings pivotably installed on the main body. The main body includes a base and a connector. One of a top and a bottom of the base defines a pair of fixing holes and a pair of tapered grooves. Each tapered groove communicates a respective fixing hole to a corresponding one of opposite lateral sides of the base near the fixing hole. Each casing includes a spindle, the spindles of the casings slide along the tapered grooves from the corresponding lateral sides of the base to the corresponding fixing holes until the spindles are snappingly engaged in the fixing holes such that the casings are operable to pivot toward the connector and cooperatively enclose the connector.

### BACKGROUND

1. Technical Field

The present disclosure relates to flash drives such as universal serial bus (USB) flash drives.

2. Description of Related Art

Most flash drives include a memory storing data, and an internal connector for connecting to a corresponding external connector to transmit data therebetween. For example, the USB flash drive has a USB connector for connecting with a USB interface embedded in another electronic apparatus. Therefore, a casing is provided for protecting the USB connector of the USB flash drive. The casing prevents the USB connector from being damaged or polluted by dust. However, the casing is generally separable from the flash drive. As a result, the casing may be misplaced or lost, leaving the USB connector unprotected. Similar problems occur with other kinds of flash drives.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of a flash drive, wherein the flash drive includes a main body and two casings.

FIG. 2 is an assembled view of the flash drive of FIG. 1, showing the main body received in the two casings completely.

FIGS. 3-5 each show the assembled flash drive, wherein at least one of the casings is rotated relative to the main body and exposes the main body.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references can mean “at least one.”

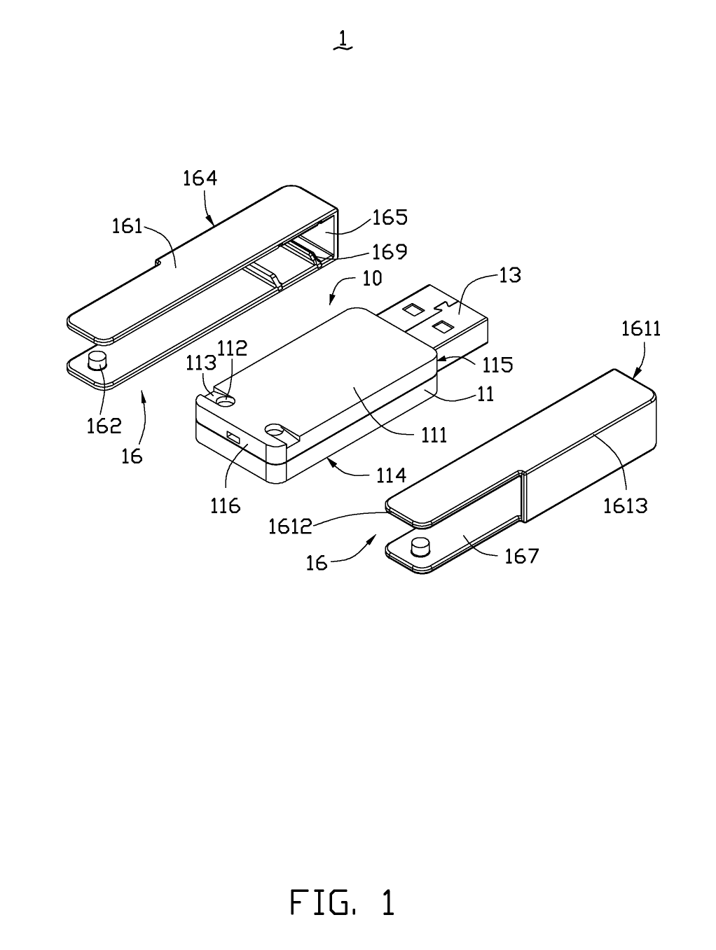

FIG. 1 shows an exemplary embodiment of a flash drive 1, which includes a main body 10 and two casings 16.

The main body 10 includes a base 11 and a USB connector 13. The base 11 includes a top surface 111, a bottom surface 114, a front surface 115, and a back surface 116. The top surface 111 is parallel to the bottom surface 114. The front surface 115 and the back surface 116 are connected to opposite sides of both the top surface 111 and the bottom surface 114. The USB connector 13 is fixed in the base 11, and protrudes out of the front surface 115 of the base 11 so as to be connected to an interface of another electrical device.

Both the top surface 111 and the bottom surface 114 define a pair of fixing holes 112 near the back surface 116 of the base 11. The top surface 111 also defines a pair of tapered grooves 113. Each tapered groove 113 communicates a corresponding fixing hole 112 of the top surface 111 to a corresponding lateral side of the base 11 near the corresponding fixing hole 112. A transverse width of each tapered groove 113 is substantially the same as a diameter of the fixing hole 112. A depth of each tapered groove 113 gradually increases from a boundary of the fixing hole 112 and the tapered groove 113 to the lateral side of the base 11, thereby defining an oblique surface between the fixing hole 112 and the lateral side of the base 11. A depth of the fixing hole 112 is greater than the depth of the tapered groove 113 at the boundary of the fixing hole 112 and the tapered groove 113.

The two casings 16 have the same structure, and are symmetrical. Each casing 16 includes two plates 161 parallel to each other. Each of the plates defines a first side 1611, a second side 1612 opposite to the first side 1611, and a third side 1613 between the first side 1611 and the second side 1612. An end piece 165 substantially perpendicularly interconnects the first sides 1611 of the two plates 161, and a side piece 164 is substantially perpendicularly connected to the third sides 1612 of the two plates 161 and one side of the end piece 165. Thereby, the end piece 165, the two plates 161 and the side piece 164 form a partially-closed accommodating space for receiving half of the base 11 and half of the USB connector 13 that protrudes out of the base 11. A spindle 162 protrudes from the inner surface of each plate 161, and is located adjacent to the second side 1612 of the plate 161. The spindle 162 is configured to be engaged in a corresponding fixing hole 112 of the base 11. Preferably, in the embodiment, at least two blocking pieces 169 protrude from an inner surface of each plate 161 adjacent to the first side 1611. In the illustrated embodiment, each blocking piece 169 is in the form of a beveled rib. A cutout 167 is defined in the side piece 164 adjacent to the second side 1612 of each plate 161.

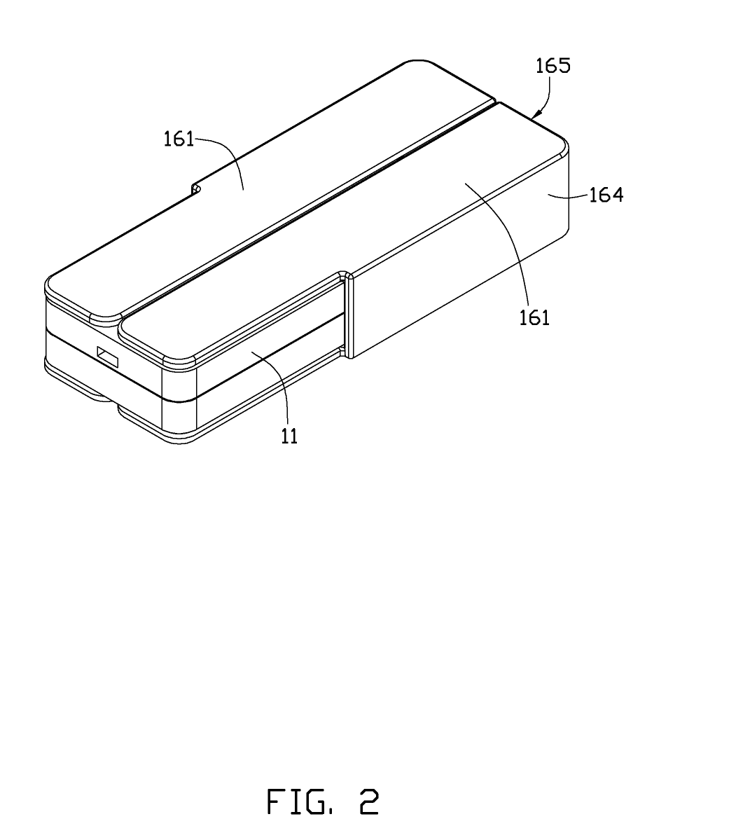

In the following description, assembly of just one of the casings 16 and the base 11 is outlined, as an example. Referring to FIG. 2, a distal end of the base 11 (having the back surface 116) is placed between the second sides 1612 of the plates 161.

The spindles 162 on the plates 161 align with the oblique surfaces of the corresponding tapered grooves 113 and slide in the tapered grooves 113 from the lateral side of the base 11 to the corresponding fixing holes 112. At the same time, the second sides 1612 of the plates 161 of the casing 16 are elastically deformed away from each other until the spindles 162 reach the boundaries of the fixing holes 112 and the tapered grooves 113, whereupon the spindles 162 of the plates 161 snappingly slide into the fixing holes 112 and engage in the fixing holes 112. Thereby, the casing 16 is pivotably mounted to the base 11.

It will be understood that the other casing 16 and the base 11 can be assembled according to the above description, therefore further detailed description is omitted. After assembly of the two casings 16 and the base 11, the casings 16 are capable of being pivoted toward the USB connector 13 to contact each other, whereby the accommodating spaces of the two casings 16 cooperatively form a single receiving space. The base 11 and the USB connector 13 of the main body 10 are completely received in the receiving space of the casings 16. The plates 161 cooperatively cover the top surface 111 and the bottom surface 114 of the base 11. The side pieces 164 cooperatively cover sides of the USB connector 13. The end pieces 165 cooperatively cover a distal end of the USB connector 13. Thereby, the USB connector 13 of the main body 10 is enclosed in the casings 16. The blocking pieces 169 of the plates 161 abut against top and bottom surfaces of the USB connector 13, to prevent the two casings 16 from being inadvertently pivoted away from each other and exposing the USB connector 13.

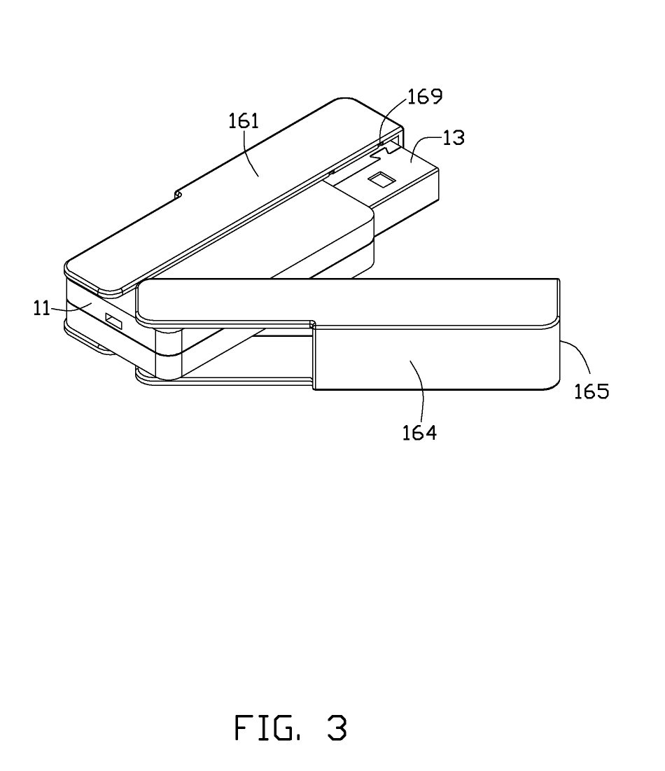

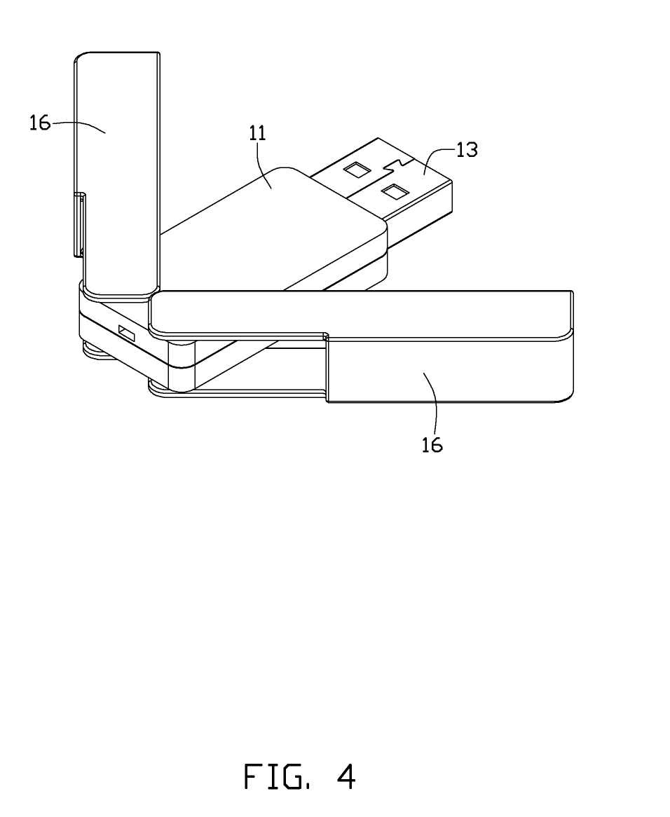

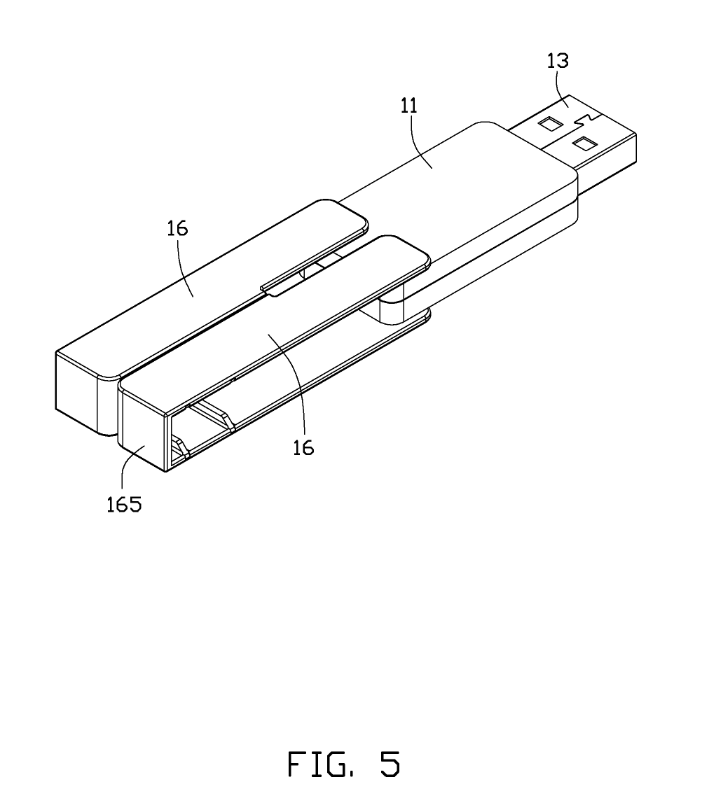

Referring to FIGS. 3-5, in use of the USB connector 13, an external force is applied to the casings 16 to cause the casings 16 to be pivoted away from each other to expose the USB connector 13.

The flash drive 1 is not limited to the above-described embodiments. For example, in an alternative embodiment, each casing 16 includes only one spindle 162 protruding from the inner surface of one of the two plates 161 of the casing 16. In such case, the base 11 only defines two fixing holes 112 and two tapered grooves 113.

It is believed that the present embodiments and their advantages will be understood from the foregoing description, and it will be apparent that various changes may be made thereto without departing from the spirit and scope of the description or sacrificing all of their material advantages, the examples hereinbefore described merely being exemplary embodiments.

What is claimed is:

1. A flash drive, comprising:
a main body comprising a base and a connector, the connector fixed in the base and protruding out of an end of the base, one of a top and a bottom of the base having a pair of fixing holes and a pair of tapered grooves defined therein, each tapered groove communicating a respective fixing hole to a corresponding one of opposite lateral sides of the base near the fixing hole;
two casings each comprising a spindle, wherein the spindles of the casings are slideable along the tapered grooves from the corresponding lateral sides of the base to the corresponding fixing holes until the spindles are snappingly engaged in the fixing holes such that the casings are operable to pivot toward the connector and cooperatively enclose the connector.

2. The flash drive of claim 1, wherein a depth of each tapered groove gradually increases from a boundary of the corresponding fixing hole and the tapered groove to the corresponding lateral side of the base.

3. The flash drive of claim 2, wherein a depth of the fixing hole is greater than the depth of the tapered groove at the boundary of the fixing hole and the tapered groove.

4. The flash drive of claim 3, wherein each casing further comprises two plates and an end piece, each plate comprises a first side, a second side opposite to the first side, and a third side between the first side and the second side, the end piece substantially perpendicularly interconnects the first sides of the plates, and the spindle of each casing protrudes from an inner surface of one of the plates.

5. The flash drive of claim 3, wherein the other one of the top and the bottom of the base also has a pair of fixing holes and a pair of tapered grooves defined therein, each tapered groove communicating a respective fixing hole to a corresponding one of the opposite lateral sides of the base near the fixing hole.

6. The flash drive of claim 5, wherein each casing further comprises two plates, an end piece substantially perpendicularly connected between ends of the plates, and another spindle, and the two spindles protrude from inner surfaces of the two plates, respectively.

7. The flash drive of claim 6, wherein a blocking piece protrudes from the inner surface of each plate, and when the casings cooperatively enclose the connector, the blocking pieces of the plates abut against surfaces of the connector to prevent the casings from pivoted away from each other and exposing the connector.

8. The flash drive of claim 7, wherein each casing further comprises a side piece, and the side piece is substantially perpendicularly connected between lateral sides of the plates and connected to one side of the end piece.

9. The flash drive of claim 1, wherein the connector is a universal serial bus (USB) connector.

10. The flash drive of claim 3, wherein a transverse width of the tapered groove is substantially the same as a diameter of the fixing hole.

11. A flash drive, comprising:
a main body comprising a base and a connector, the base having two fixing holes and two tapered grooves defined therein, each tapered groove communicating a corresponding fixing hole to a corresponding one of opposite lateral sides of the base near the fixing hole;
two casings each comprising a spindle, wherein the spindles of the casings are slideable along the tapered grooves from the corresponding lateral sides of the base to the corresponding fixing holes until the spindles are snappingly engaged in the fixing holes such that the casings are pivotable toward the connector until the casings cooperatively enclose the connector.

12. The flash drive of claim 11, wherein a depth of each tapered groove gradually increases from a boundary of the corresponding fixing hole and the tapered groove to the corresponding lateral side of the base.

13. The flash drive of claim 12, wherein a depth of the fixing hole is greater than the depth of the tapered groove at the boundary of the fixing hole and the tapered groove.

14. The flash drive of claim 13, wherein each casing further comprises two plates and an end piece, each plate comprises a first side, a second side opposite to the first side, and a third side between the first side and the second side, the end piece substantially perpendicularly interconnects the first sides of the plates, and the spindle of each casing protrudes from an inner surface of one of the plates.

15. The flash drive of claim 14, wherein the base further comprises a top surface, a bottom surface, a first surface and a second surface, the bottom surface is parallel to the bottom surface, and the first surface and the second surface are connected to opposite sides of both the top surface and the bottom surface, the connector is fixed in the base and protrude out of the base from the front surface.

16. The flash drive of claim 15, wherein the base having another two fixing holes and another two tapered grooves defined therein, the top surface and the bottom surface of the base each have two fixing holes and two tapered grooves near the second surface, and each tapered groove communicating a respective fixing hole to a corresponding one of the opposite lateral sides of the base near the fixing hole, each casing comprised another spindle, each spindle protrudes from an inner surface of each plate.

17. The flash drive of claim 16, wherein a blocking piece protrudes from the inner surface of each plate, and when the casings cooperatively enclose the connector, the blocking pieces of the plates abut against surfaces of the connector to prevent the casings from pivoted away from each other and exposing the connector.

18. The flash drive of claim 17, wherein each casing further comprises a side piece, and the side piece is substantially perpendicularly connected between lateral sides of the plates and connected to one side of the end piece.

19. The flash drive of claim 11, wherein the connector is a universal serial bus (USB) connector.

20. The flash drive of claim 13, wherein a transverse width of the tapered groove is substantially the same as a diameter of the fixing hole.
